(19) United States
(12) Patent Application Publication
(10) Pub. No.: US 2022/0350372 A1
(43) Pub. Date: Nov. 3, 2022

(54) OPERATING STATES BASED ON LID POSITIONS AND DEVICE MOVEMENTS

(71) Applicant: Hewlett-Packard Development Company, L.P., Spring, TX (US)

(72) Inventors: Hui Leng Lim, Spring, TX (US); Alexander Wayne Clark, Spring, TX (US); Alan Man Pan Tam, Spring, TX (US)

(73) Assignee: Hewlett-Packard Development Company, L.P., Spring, TX (US)

(21) Appl. No.: 17/636,067

(22) PCT Filed: Oct. 29, 2019
(86) PCT No.: PCT/US2019/058590

§ 371 Date: Feb. 17, 2022

(51) Int. Cl. G06F 1/16

(52) U.S. Cl. CPC G06F 1/1677; G06F 1/1694

(57) ABSTRACT

An example non-transitory computer readable medium store a set of instructions when executed cause a controller of a computing device to determine a position of a lid portion of the computing device based on a first signal from a first sensor and determine movement of the computing device based on a second signal from a second sensor. The instructions when executed further cause the controller to transmit a command to a processor of the computing device in response to the determined position of the lid portion and the determined movement, the command to direct the processor to maintain a current operating state.

### BACKGROUND

Computing devices have different operating states to reduce power consumption. For example, the specifications of the Advanced Configuration and Power Interface (ACPI) define six operating states from S0 state to S5 state.

### BRIEF DESCRIPTION OF FIGURES

Various examples may be more completely understood in consideration of the following detailed description in connection with the accompanying drawings, in which:

FIG. 1 illustrates an example apparatus for maintaining an operating state, consistent with the present disclosure;

FIG. 2 illustrates an example computing device including non-transitory computer readable medium storing executable instructions, consistent with the present disclosure;

FIG. 3 illustrates another example computing device including non-transitory computer readable medium storing executable instructions, consistent with the present disclosure;

FIG. 4 illustrates another example apparatus for maintaining an operating state, consistent with the present disclosure; and

FIGS. 5A-5B illustrate example methods for overriding default operating system settings, consistent with the present disclosure.

### DETAILED DESCRIPTION

Computing devices may be designed to operate in different operating states involving different power levels. In certain non-limiting examples, aspects of the present disclosure may involve an override of default operating system (OS) settings of a host computing device in response to satisfaction of a condition associated with a position of a lid portion of the computing device and movement of the computing device. The override of the default OS settings in response to the different conditions may cause the computing device to maintain a working state such that a function being performed by the computing device is uninterrupted. Under the default OS settings, the computing device may enter a lower power operating state than the working state and cause a function to be interrupted.

A computing device may transition to different operating states depending on different conditions. The conditions that trigger the transitions may be defined in default OS settings used by the OS of the computing device. The default OS settings may be revised or customized to set different conditions. In accordance with various examples, a computing device disregards default OS settings in response to signals from sensors that indicate a particular lid position and movement of the computing device. The computing device includes a controller that receives the signals from a lid sensor and an accelerometer indicative of the lid position and movement of the computing device. In response to signals from the sensors indicating a particular condition is satisfied, the controller overrides the default OS settings. For example, the controller notifies the processor of the computing device to disregard the default OS settings and to maintain a working state. Additional signals received from the sensors may indicate the condition is no longer met, and, in response, the controller notifies the processor to restore or revert back to the default OS settings. The computing device may revise the override or disregard of the default OS settings based on feedback data indicating to use the default OS settings.

A specific example is directed to a computing device that has non-transitory computer readable medium storing a set of instructions. The instructions when executed cause a controller of the computing device to determine a position of a lid portion of the computing device based on a first signal from a first sensor, and determine movement of the computing device based on a second signal from a second sensor. The instructions are further executed to transmit a command to a processor of the computing device in response to the determined position of the lid portion and the determined movement, the command to direct the processor to maintain a current operating state.

In other specific examples, a computing device has non-transitory computer readable medium storing a set of instructions when executed cause a processor of the computing device to receive, at an OS of the computing device, a command that indicates a position of a lid portion of the computing device and movement of the computing device satisfy a condition. In response to the command, the processor disables a state transition of the OS to maintain a current operating state of the OS. The disabled state transition may be associated with default OS settings, and the current operating state may include a working state.

Other examples are directed to an apparatus which includes the computing device. The apparatus includes a housing having a base portion coupled to a lid portion. The apparatus further includes a first sensor, a second sensor, and a controller. The first sensor obtains a first signal indicative of a position of the lid portion with respect to the base portion. The second sensor obtains a second signal indicative of movement of the apparatus. The controller detects the position of the lid portion and movement of the apparatus based on the first signal and the second signal, and determines the detected position of the lid portion satisfies a first condition and the detected movement of the apparatus satisfies a second condition. In response to the satisfaction of the first condition and the second condition, the controller maintains an OS of the apparatus at a working state.

By maintaining the OS of the apparatus at a current operating state, such as the working state, the computing device may maintain a function currently being implemented. Under the default OS settings, the computing device may interrupt or discontinue performing the function. As an example, the movement of the computing device and/or position of lid, under the default OS settings, may cause the computing device to enter an operating state associated with reduced power and reduced functionalities compared to the current operating state. In various examples, the controller may direct the processor to disregard the default OS settings to block the computing device from entering into the reduced power state and to continue performing the particular function.

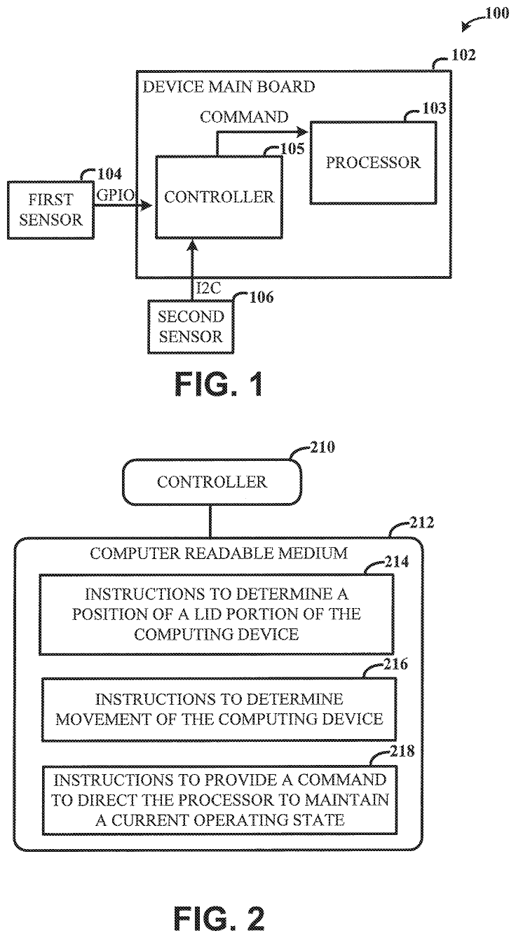

Turning now to the figures, FIG. 1 illustrates an example apparatus for maintaining an operating state, consistent with the present disclosure. The apparatus 100 detects different conditions which cause an override of default OS settings. The different conditions may be dependent on or include a position of a lid portion of a computing device and movement of the computing device. When a particular condition is met, a current operating state of the computing device is maintained. The operating state, under the default OS settings, may have changed to a lower power operating state.

The apparatus 100 includes a device main board 102 that is coupled to a first sensor 104 and a second sensor 106. The device main board 102 may form part of a computing device that is portable, such as a laptop computer or tablet. The computing device has a closeable lid and/or cover, herein referred to as a “lid portion”. The lid portion is coupled to a base portion which includes the device main board 102. Although not illustrated, the computing device may include a housing that includes the base portion and the lid portion. The device main board 102 may include a processor 103 which may be a central processing unit (CPU) and/or form part of a system on a chip (SOC), in some examples. The processor 103 may include or be coupled to a memory that includes an OS of the computing device, with the processor 103 executing the OS.

In some examples, the processor 103 may be implemented as a multi-core processor or a processor circuit implemented as a set of processor circuits integrated as a chip set. In these and other examples, it is appreciated that such processor circuitry includes a single, or multiple computer circuits including memory circuitry for storing and accessing the firmware or program code to be accessed or executed as instructions to perform the related operation(s).

The OS of the computing device may be associated with a plurality of different operating states. The operating states may include a plurality of different power states, in which different functions of the computing device are enabled and/or disabled. Default OS settings may define conditions which when met or are satisfied, cause transition of the OS to the particular operating state. As a non-limiting example, closing the lid portion of the computing device may cause the operating state to transition to a lower power state. As another example, pressing the power button of the computing device may cause the operating state to transition to an off-state.

As a specific example, the specifications of the Advanced Configuration and Power Interface (ACPI) define six operating states (power states) from S0 state to S5 state. In S0 state, a computer operates, and the processor 103 and other devices can automatically transition to a power-saving mode for operation based on the default OS settings in accordance with the access frequency and the load status. S1 state to S4 state are called sleeping states, where the processor 103 stops execution of instructions.

The ratio of reduction in power consumption increases in the order from S1 to state to S4 state, and a time for resumption of S0 state from each state increases in this order. S3 state is called suspend or standby where the context of the processor in S0 state is stored in a main memory and electric power to the main memory is secured. S4 state is called hibernation where the context of the processor and the content stored in the main memory are stored in a nonvolatile recording medium. S5 state is a soft-off state where the power consumption is the same as in S4 state.

The default OS settings may be blocked or overridden by a controller 105. In many instances, a user may prefer for the computing device to remain in a current operating state, such as an S0 state, when the default OS settings may indicate to transition to a different operating state. For example, a function may currently be implemented by the processor 103 and the user may want the function to continue uninterrupted. The override may be responsive to a position of the lid portion of the computing device and movement of the computing device, such as when the user is moving with the computing device and has the lid portion in an open position or a closed position. In such examples, the device main board 102 further includes the controller 105 which is communicatively coupled to a plurality of sensors, such as the illustrated first sensor 104 and second sensor 106. The controller 105 determines a position of the lid portion and movement of the computing device using signals received from the first and second sensors 104, 106. As used herein, a controller refers to or includes a chip, an expansion card, or a stand-alone device that interfaces with the processor 103 of the computing device, such as a CPU of the computing device. In some non-limiting examples, the controller 105 may refer to or include an embedded controller, though examples are not so limited.

The closed position of the lid portion, as used herein, includes or refers to the lid or cover of the computing device being proximate to the base portion such that the lid or cover impedes access to at least a portion of the base portion. For example, the lid portion may be in a closed position in response to the lid or cover blocking user access to a keyboard of a laptop computer or a touch screen of a tablet. The open position includes or refers to the lid or cover of the computing device being a threshold distance away from the computing device and/or otherwise allowing access to input components of the base portion. Using the above examples, the lid is in an open position in response to the lid being in a position in which the user may access the keyboard of the laptop computer or the touch screen of the tablet. As a specific example, for a tablet with a cover, the cover may be in an open position in response to the cover being proximate to an opposite side of the tablet from the touch screen, which be referred to as a “backside”.

The first and second sensors 104, 106 may include a variety of different types of sensors. Example sensors include a Hall Effect sensor, a capacitive sensor, a magneto resistive sensor, an accelerometer, among other types of sensors. In a specific example, the first sensor 104 includes a Hall Effect sensor and the second sensor 106 includes an accelerometer, although examples are not so limited. The first sensor 104 obtains a first signal indicative of a position of the lid portion with respect to the base portion and transmits the first signal to the controller 105. The second sensor 106 obtains a second signal indicative of movement of the computing device and transmits the second signal to the controller 105. The first sensor 104 may be located within the lid portion and/or the base portion, and the second sensor 106 may be located within or otherwise coupled to the base portion of the computing device, although examples are not so limited.

The apparatus 100 may include communication interfaces, such as a first communication interface associated with the first sensor 104, a second communication interface associated with the second sensor 106, and a third communication interface between the controller 105 and the processor 103. The signals from the first and second sensors 104, 106 are provided via the communication interfaces. In the specific example, the first sensor may communicate via a general-purpose input/output (GPIO) signal and the second sensor communicates via an inter-integrated circuit (I2C) signal. The third communication interface may include an enhanced Serial Peripheral Interface (eSPI) bus interface used to communicate eSPI commands.

The controller 105 uses the signals from the first and second sensors 104, 106 to determine the position of the lid portion and the movement of the computing device. For example, the controller 105 may determine whether to override the default OS settings of the computing device. The controller 105, responsive to the determined position of the lid portion and the determined movement, transmits a command to the processor 103 to cause the OS to override the default OS settings and maintain a current operating state. For example, the determined position of the lid portion and movement of the computing device are used to determine if a condition is satisfied, and in response to the satisfaction of the condition, the command is transmitted by the controller 105 to the processor 103.

The processor 103 responds to the command by maintaining a current operating state. For example, the processor 103 may maintain a working state by disregarding the default OS settings. As used herein, a working state includes or refers to an operational state of a computing device in which the system is awake and running, such as the system being fully usable. When the computing device is in a working state, hardware components that are not currently in use may enter a lower power state to reduce power consumed by the computing device. An example working state includes a fully on and operational state, such as S0. The override of the default OS settings may be responsive to device movement with the lid portion in an open position, or alternatively, a closed position. The override enables continuous operation and productivity of the computing device by keeping the computing device active when the lid is open or closed and the user is moving with the computing device. In a specific example, the override of the default OS settings is responsive to the computing device performing a conference call, device movement and the lid portion being in a closed position. The override, in such an example, allows for an uninterrupted conference call experience when the lid is closed and the user is on the move. The override of the default OS settings may avoid and/or block the OS from going into an unintended standby or shut down state.

As specific example, a user may be in a conference call using a laptop computer. While in the conference call, the user moves to a different room with the laptop computer. During the movement, the user may not be able to provide inputs to the laptop computer for a greater than a threshold amount of time. Under the default OS settings, the laptop computer may enter a reduced power state such that the conference call is discontinued by the laptop computer and laptop computer reinitiates the conference call upon transitioning to the working state. The controller 105 may detect the lid position and movement of the laptop computer, and in response to the satisfaction of the condition, provide the command to the processor 103 to direct the processor 103 to disregard the default OS settings and maintain the conference call being performed by the laptop computer.

In various examples different example conditions may cause the override of the default OS settings. Additionally, the conditions may be learned and/or updated over time by the computing device based on use patterns of the user, as further described herein.

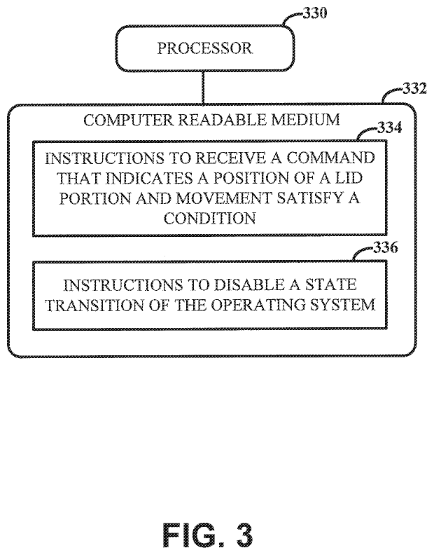

FIG. 2 illustrates an example computing device including non-transitory computer readable medium storing executable code, consistent with the present disclosure. The computing device may be portable, such as a tablet, and/or a laptop computer, and includes a lid portion and a base portion, as previously described.

The computing device has a controller 210 and computer readable medium 212 storing a set of instructions 214, 216, 218. The computer readable medium 212 may, for example, include read-only memory (ROM), random-access memory (RAM), electrically erasable programmable read-only memory (EEPROM), Flash memory, a solid state drive, and/or discrete data register sets. The controller 210 may communicate with a processor of the computing device that executes the OS, such as a CPU of the computing device.

At 214, the controller 210 may determine a position of a lid portion of the computing device based on a first signal from a first sensor. The position may include one of an open position and a closed position. At 216, the controller 210 determines movement of the computing device based on a second signal from a second sensor. At 218, the controller 210 transmits a command to a processor of the computing device in response to the determined position of the lid portion and the determined movement. As previously described, the command directs the processor to maintain a current operating state. In various examples, the command directs the processor to maintain the current operating state by disregarding default OS settings.

In specific examples, the command is transmitted in response to a determination that the position of the lid portion satisfies a first condition and the movement of the computing device satisfies a second condition. For example, the command is transmitted in response to the lid portion being in a closed position and the computing device is moving, and the command is to cause the processor to maintain a function currently being performed by the computing device. The function, in such an example, may include a conference call that is maintained or continued to be performed. The command causes the processor to maintain the conference call being performed by the computing device. In more specific examples, the processor disregards the default OS settings and maintains the OS in the S0 state, which results in wireless network (Wi-Fi) and/or wireless wide area network (WWAN) connection remaining on, and/or a Bluetooth (BT) connection remaining on. The processor may restore or revert to the default OS settings in response to the conference discontinuing and/or another command from the controller that indicates or in responsive to the movement of the computing device ceasing and/or the lid being in an open position.

As another example, the command is transmitted in response to the lid portion being in an open position and the computing device is moving, and the command is to cause the processor to maintain a function currently performed by the computing device. The processor may disregard the default OS settings and maintain the OS in the S0 state, and may provide an indication to notify the user of the maintained S0 state. The indication may include, for example, a sound signal provided by a voice control application, a visual indication provided on a display of the computing device and/or a light indication that indicates the default OS settings are overridden, among other indications.

In various examples, the controller 210 may revise the instructions based on feedback data. The feedback data may indicate to use the default OS settings to control state transitions of the OS. For example, the feedback data may include or be indicative of a condition that indicates to use or to maintain the default OS settings in response to the determined position of the lid portion and the determined movement. The condition may include an input to the computing device provided by the user in response to the current operating state being maintained. Example inputs includes a user pressing a power button and/or a user providing an indicating, such as an input to an application, which indicates maintaining the current operating state was unintended. As a specific example, the user may press the power button greater than a threshold number of times and/or press the power button for greater than a threshold time.

The input may be used, along with other conditions, to revise when the controller 210 transmits the command to override the default OS settings to the processor of the computing device. As non-limiting examples, the processor that executes the OS may learn patterns of the user over time and which indicate that the default OS settings may be maintained in response to the determined position of the lid and the movement. Examples may include the user moving at greater or less than a threshold speed, the computing device being placed at a vertical angle, such as being placed in a backpack, a particular function being implemented, among other use patterns, and which may be adapted to specific users. The feedback for revising the disregard or override of the default OS settings may be generated by the controller and/or the processor. For example, the feedback from a button press on a keyboard may be implemented by a scan code through the controller. In other examples, a button press may be on a touch screen and/or input to a graphical user interface, which is registered by the processor.

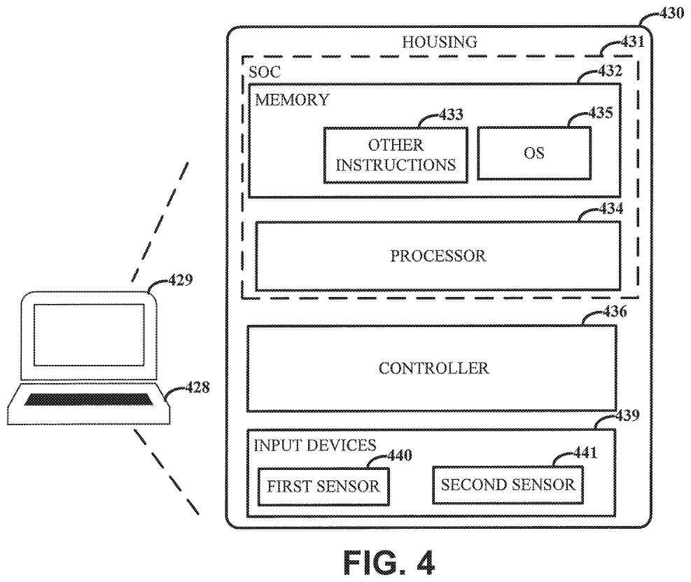

FIG. 3 illustrates another example computing device including non-transitory computer readable medium storing executable code, consistent with the present disclosure. The computing device may be portable, such as a tablet, and/or a laptop computer, and includes a lid portion and a base portion, as previously described.

The computing device has a processor 330 and computer readable medium 332 storing a set of instructions 334, 336. The computer readable medium 332 may, for example, include ROM, RAM, EEPROM, Flash memory, a solid state drive, and/or discrete data register sets. The processor 330 and/or computer readable medium 332 may be or form part of a CPU or SOC of the computing device coupled to a controller, and the processor 330 executes the OS.

At 334, the processor 330 may receive, at an OS of the computing device, a command that indicates a position of a lid portion of the computing device and movement of the computing device satisfy a condition. In response to the command, at 336, the processor 330 may disable a state transition of the OS to maintain a current operating state. Default OS settings may define when the state transition is to occur. The command causes the processor 330 to disable the state transition by disregarding the default OS settings. The state transition may be defined to occur in the default OS settings.

As previously described, the condition may include the lid portion being in a closed position and the computing device is moving, and in response to the command, the processor 330 is to maintain a conference call being performed by the computing device. In other examples, the condition includes the lid portion being in an open position and the computing device is moving, and in response to the command, the processor 330 is to maintain a function being performed by the computing device. The current operating state may include a working state, such as a fully on and functional state. In some examples, the condition may include a first condition associated with a position of the lid portion and a second condition associated with the movement of the computing device. The second condition may include different threshold speeds of movement, in some examples.

In various instances, the controller of the computing device may receive a plurality of signals from the first and second sensors. The controller may determine the position of the lid portion and the movement of the computing device based on a first signal from a first sensor of the plurality of sensors and a second signal from a second sensor of the plurality of sensors, the first signal and the second signal being among the plurality of signals. The controller may transmit a second command to the processor 330 of the computing device in response to a third signal from the first sensor and a fourth signal from the second sensor indicating the condition is currently unsatisfied. The second command may direct the processor 330 to restore the default OS settings. For example, in response to the computing device being stationary and/or the lid portion being in the open position or the closed position, the controller outputs the second command to the processor 330 to cause restoration of default OS settings. The processor 330 receives the second command, and in response, restores the default OS settings. As an example, in response to a defined timeout time, the computing device transitions to a lower power operating state and/or the previously maintained function may be interrupted.

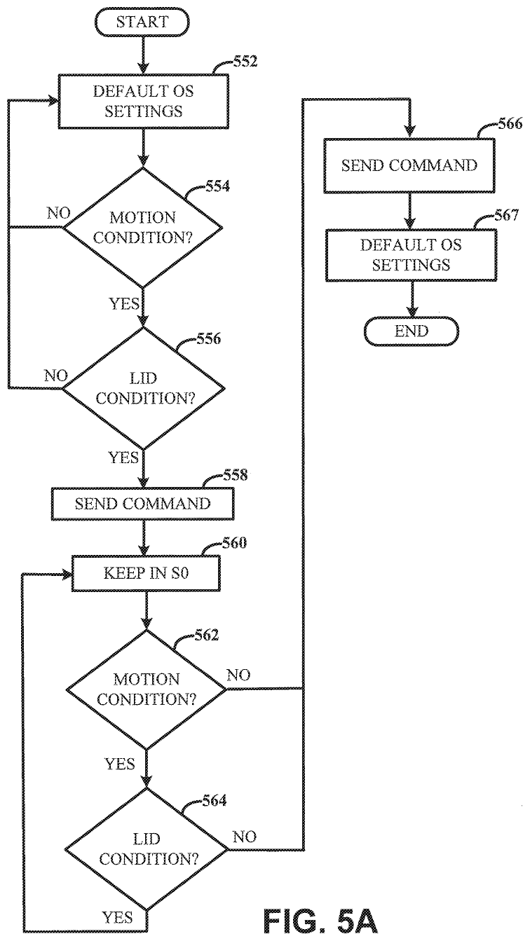

The computing device illustrated by FIG. 3 may perform a variety of additional functions, such as those described in connection with FIG. 2 and FIG. 4. As an example, the computing device may receive an input that indicates to override the command and which may cause the processor 330 to maintain the current operating state. The input may be indicative of the condition being currently unsatisfied. As another example, a user may press the power button and/or press the power button greater than a threshold number of times, which indicates to override the command. In response to the input, the processor 330 restores the default OS settings and/or powers-down, as described above. The controller may recognize the input and provide a command to the processor 330 to restore the default OS settings.

FIG. 4 illustrates another example apparatus for maintaining an operating state, consistent with the present disclosure. As previously described, the apparatus may include a computing device having a housing 430 and that includes a memory 432 and a processor 434, which may optionally be a CPU and/or form part of a SOC 431. The memory 432 stores the OS 435 and other computer readable instructions 433 which may be executed by the processor 434.

The apparatus may include a computing device having the housing 430 that includes a base portion 428 coupled to a lid portion 429. In specific examples, the housing 430 includes the base portion 428 and the lid portion 429. However examples are not so limited and the lid portion 429 may be separate from the housing 430, such as a cover for a tablet. In the specific example illustrated by FIG. 4, the base portion 428 may include a main circuit board, such as previous described by FIG. 1, and includes an input component such as the illustrated keyboard. The lid portion 429 includes a display. Although examples are not so limited, and the base portion may include a touch display, as described above.

The apparatus includes input devices 439 used to provide inputs to the computing device. The input devices 439 may form part of the computing device, and be within the housing 430, and/or may be separate therefrom. Although only the first sensor 440 and the second sensor 441 are illustrated, additional sensors may be included in the housing or in communication with the computing device, and further input devices 439 may be included, such as a keyboard, a computer mouse, a display, and other input devices.

The first sensor 440 obtains a first signal that is indicative of the position of the lid portion 429 with respect to the base portion 428. As previously described, the position of the lid portion 429 may include an open position or a closed position. The second sensor 441 obtains a second signal indicative of movement of the apparatus.

The first and second sensors 440, 441 may be communicatively coupled to a controller 436 of the computing device. Although not illustrated, the controller 436 may include a processor and memory, and the processor of the controller 436 may execute computer readable instructions stored on the memory of the controller 436. The controller 436 may be embedded within the housing 430 in some examples. The controller 436 may receive the first and second signals from the first sensor 440 and second sensor 441. For example, the controller 436 detects the position of the lid portion 429 and the movement of the apparatus based on the first signal from the first sensor 440 and the second signal from the second sensor 441, and determines the detected position of the lid portion 429 satisfies a first condition and the detected movement of the apparatus satisfies a second condition. In response to the satisfaction of the first condition and the second condition, the controller 436 maintains an OS 435 of the apparatus at a working state. The controller 436 may maintain the OS 435 at the working state, for example, by transmitting a command to the processor 434 of the apparatus. The command is to cause the processor 434 to maintain the working state, such as a fully on and operational state. In various examples, the OS 435 may be in the working state prior to the command. In such examples, the working state may be referred to as the current operating state. In specific examples, the controller 436 transmits the command to the processor 434, and the processor 434 maintains the working state in response to the command from the controller 436 by disregarding default OS settings. The command may cause the apparatus to maintain a function being performed by the apparatus, such as a conference call.

The first and second conditions may be dependent on various factors. For example, when the processor 434 is performing a conference call, the first condition includes the lid portion 429 being in a closed position and the second condition includes the apparatus moving. The second condition, in specific examples, may include a threshold speed of the movement. The controller 436 transmits the command to the processor 434 in response to the determination that the lid portion 429 is in the closed position and the apparatus is moving. The transmitted command causes the processor 434 to maintain a conference call being performed.

As another example, the first condition includes the lid portion 429 being in an open position and the second condition includes the apparatus moving. The controller 436 transmits the command to the processor 434 in response to the determination that the lid portion 429 is in the open position and the apparatus is moving. The transmitted command causes the processor 434 to maintain a function being performed. Such an example may be used to keep a computing device active and exhibiting continuous productivity, when the user is moving with the lid portion 429 open.

In various specific examples, the disregard of the default OS settings may be adapted based on feedback data. For example, the processor 434 may receive an additional input to the apparatus indicating to override the command. The additional input may include an input to an input device 439, such as a user pressing a power button. The processor 434, in response to additional input to the apparatus indicating to override the command, transitions operating states and/or provides feedback data to the controller 436. The processor 434 may, for example, restore default OS settings and change the operating state, such as powering down and/or going into a sleep state. As previously described, the feedback may be indicative of a third condition that causes the override of the command.

The controller 436 may revise the instructions based on the feedback data. The feedback data may indicate to use the default operating systems settings. As a specific example, the feedback data includes a third condition that indicates to maintain default OS settings in the future and/or in response to satisfaction of the first condition, the second condition, and the third condition. As described above, the input to the apparatus may include a power button press on a keyboard. The controller 436 recognizes the input and provides a command to the processor 434.

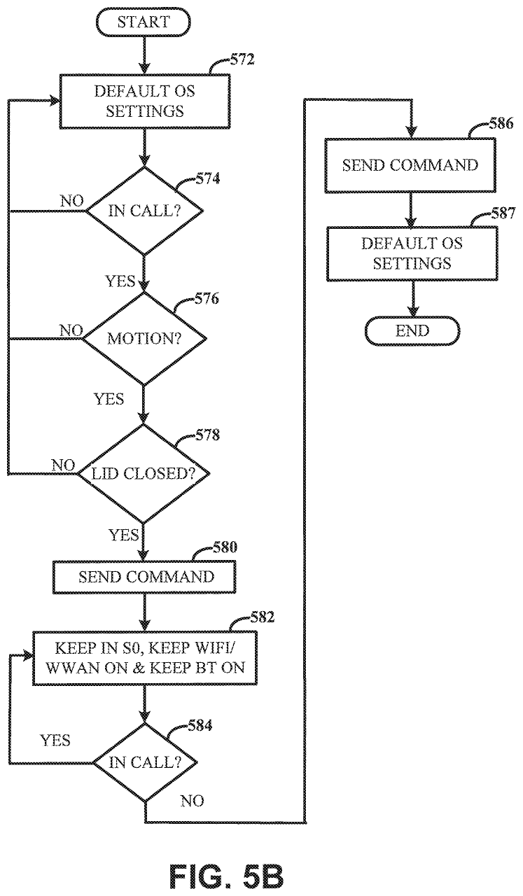

FIGS. 5A-5B illustrate example methods for overriding default OS settings, consistent with the present disclosure. The methods may be performed by any of the above illustrated computing devices and/or apparatus.

FIG. 5A illustrates an example method for overriding the default OS settings to provide continuous productivity of a computing device in response to the lid being open and the computing device moving. At 552, the computing device is operating under default OS settings. At 554, a determination is made on whether a motion condition is satisfied. The motion condition may be satisfied in response to a signal from an accelerometer that indicates the computing device is moving and/or is moving at greater than a threshold speed. In response to the motion condition being unsatisfied, the default OS settings are maintained, at 552.

In response to the motion condition being satisfied, at 556, a determination is made on whether a lid position condition is satisfied. The lid position condition may be satisfied in response to a signal from a Hall Effect sensor indicating the lid is in an open position or a closed position. In response to the lid position condition being unsatisfied, the default OS settings are maintained, at 552. As may be appreciated, the order of determining satisfaction of the conditions is not limited to that illustrated by FIG. 5A and may include determination of the lid position condition followed by the motion condition.

In response to the lid condition being satisfied, at 558, the controller of the computing device sends a command to the processor, such as the CPU. The command causes, at 560, the processor to keep the computing device in the S0 state, thereby causing disregard of default OS settings by the processor. The processor may further notify the user of the computing device maintaining the S0 state, such as by a voice controlled application that notifies the user that the computing device is kept active.

When at least one of the conditions are no longer met, the controller may notify the processor to restore or revert to default OS settings. For example, the controller may continue to determine if the motion condition is satisfied, at 562, and the lid condition is satisfied, at 564. If both remain satisfied, the computing device remains in the S0 state, at 560. In response to either or both conditions being unsatisfied, the controller instructs the processor to restore, revert, or otherwise comply with default OS settings. For example, the controller may send another command to the processor, at 566, and in response to the command, at 567, the processor reverts the computing device to the default OS settings. For example, the computing device may enter a sleep state after a normal timeout threshold.

FIG. 5B illustrates an example method for overriding the default OS settings to provide an uninterrupted conference call in response to the lid being open and the computing device moving.

At 572, the computing device is operating under default OS settings. At 574, a determination is made on whether the computing device is implementing a conference call. In such examples, the computing device implementing a conference call may be referred to as a function condition, with the function condition being satisfied in response to determining the computing device is implementing a conference call (or other function). The controller may determine a conference call is being implemented based on functions associated with the conference call, such as use of the microphone and a communication connection and/or a particular application running. The determination may be in response to an instruction provided from the processor to the controller. In response to determining a conference call is discontinued or completed, the default OS settings are maintained, at 572.

In response to determining the computing device is implementing a conference call, at 576, a determination is made on whether a motion condition is satisfied. The motion condition may be satisfied in response to a signal from an accelerometer that indicates the computing device is moving and/or is moving at greater than a threshold speed. In response to the motion condition being unsatisfied, the default OS settings are maintained, at 572.

In response to the motion condition being satisfied, at 578, a determination is made on whether a lid position condition is satisfied. The lid position condition may be satisfied in response to a signal from a Hall Effect sensor indicating the lid is in a closed position. In response to the lid position condition being unsatisfied, the default OS settings are maintained, at 572. As may be appreciated, the order of determining satisfaction of the conditions is not limited to that illustrated by FIG. 5B and may include determination of the lid position condition followed by the motion condition.

In response to the lid condition being satisfied, at 580, the controller sends a command to the processor. The command causes, at 582, the computing device to keep in the S0 state, thereby causing disregard of default OS settings. More specifically, the processor may disregard the default OS settings and maintain the computing device in the S0 state, which results in the Wi-Fi and/or WWAN connection remaining on, and/or a BT connection remaining on. At 584, a determination is made on whether the conference call continues or has ended. The processor may restore or revert to the default OS settings in response to the conference call ending, as illustrated by 586 and 587. In specific examples, the controller may instruct the processor to cease the disregard of the default OS settings, as illustrated by 586, and which may result in a transition to a lower power operating state. For example, the controller sends a second command to the processor. The second command causes the processor to restore or revert to the default OS settings. If the conference call is occurring, the computing device remains in the working state, at 582, which may occur whether the computing device is moving or is stationary.

Although not illustrated, the methods illustrated by FIGS. 5A and 5B may be combined. For example, a controller may obtain signals from sensors of the computing device that indicate a position of the lid portion and movement of the computing device, and compare the determination to different conditions that may trigger the disregard or override of the default OS settings. The different conditions may be associated with a user being in a conference call and moving, such as when a user is moving from one location to another and may prefer the conference call to be uninterrupted during the movement. Other conditions may be associated with specific functions being implemented and the computing device moving. Additionally, the processor and/or controller may update the conditions over time and in response to feedback provided to the computing device. The feedback may include user inputs indicating conditions in which the default OS settings are to be implemented by the OS, as described above.

What is claimed is:

1. A non-transitory computer readable medium storing a set of instructions when executed cause a controller of a computing device to:
determine a position of a lid portion of the computing device based on a first signal from a first sensor;
determine movement of the computing device based on a second signal from a second sensor; and
transmit a command to a processor of the computing device in response to the determined position of the lid portion and the determined movement, the command to direct the processor to maintain a current operating state.

2. The non-transitory computer readable medium of claim 1, wherein the processor is to maintain the current operating state by disregarding default operating system settings.

3. The non-transitory computer readable medium of claim 1, wherein when executed the instructions further cause the controller to transmit the command in response to a determination that the position of the lid portion satisfies a first condition and the movement of the computing device satisfies a second condition, and the current operating state includes a fully on and operational state.

4. The non-transitory computer readable medium of claim 1, wherein when executed the instructions further cause the controller to transmit the command in response to determining the lid portion is in a closed position and the computing device is moving, and the command is to cause the processor to maintain a function currently performed by the computing device.

5. The non-transitory computer readable medium of claim 1, wherein when executed the instructions further cause the controller to transmit the command in response to the lid portion being in an open position and the computing device is moving, and the command is to cause the processor to maintain a function currently performed by the computing device.

6. The non-transitory computer readable medium of claim 1, wherein when executed the instructions further cause the controller to transmit the command in response to the lid portion being in one of a closed position and an open position and the computing device is moving, the command is to cause the processor to maintain a conference call being performed by the computing device.

7. The non-transitory computer readable medium of claim 1, wherein when executed the instructions further cause the controller to revise the instructions based on feedback data, the feedback data indicating to use default operating system settings.

8. A non-transitory computer readable medium storing a set of instructions when executed cause a processor of a computing device to:
receive, at an operating system of a computing device, a command that indicates a position of a lid portion of the computing device and movement of the computing device satisfy a condition; and
in response to the command, disable a state transition of the operating system to maintain a current operating state of the operating system.

9. The non-transitory computer readable medium of claim 8, wherein the condition includes the lid portion being in a closed position and the computing device is moving, and in response to the command, the processor is to maintain a conference call being performed by the computing device.

10. The non-transitory computer readable medium of claim 8, wherein the condition includes the lid portion being in an open position and the computing device is moving, and in response to the command, the processor is to maintain a function being performed by the computing device.

11. The non-transitory computer readable medium of claim 8, wherein when executed the instructions further cause the processor to:
receive an input indicative of the condition being currently unsatisfied; and
in response to the input, restore default operating system settings.

12. An apparatus comprising:
a housing including a base portion coupled to a lid portion;
a first sensor to obtain a first signal indicative of a position of the lid portion with respect to the base portion;
a second sensor to obtain a second signal indicative of movement of the apparatus; and
a controller to:
detect the position of the lid portion and the movement of the apparatus based on the first signal and the second signal;
determine the detected position of the lid portion satisfies a first condition and the detected movement of the apparatus satisfies a second condition; and
in response to the satisfaction of the first condition and the second condition, maintain an operating system of the apparatus at a working state.

13. The apparatus of claim 12, the apparatus further including:
a memory to store executable computer readable instructions and the operating system; and
a processor to execute the instructions to maintain the working state in response to a command from the processor, the working state including a fully on and operational state.

14. The apparatus of claim 12, wherein the first condition includes the lid portion being in a closed position and the second condition includes the apparatus moving, and the controller is to transmit a command to maintain the operating system at the working state in response to a determination that the lid portion is in the closed position and the apparatus is moving, the command to cause the apparatus to maintain a conference call being performed.

15. The apparatus of claim 12, wherein the first condition includes the lid portion being in an open position and the second condition includes the apparatus moving, and the controller is to transmit a command to maintain the operating system at the working state in response to determining the lid portion is in the open position and the apparatus is moving, the command to cause the apparatus to maintain a function being performed.
